(19) United States
(12) Patent Application Publication
(10) Pub. No.: US 2011/0141303 A1
(43) Pub. Date: Jun. 16, 2011

(54) ELECTRONIC CAMERA

(75) Inventors: Masayoshi Okamoto, Daito-shi (JP); Jun Kiyama, Higashi-Osaka-shi (JP); Yukio Mori, Hirakata-shi (JP)

(73) Assignee: SANYO ELECTRIC CO., LTD., Moriguchi-shi (JP)

(21) Appl. No.: 12/948,235

(22) Filed: Nov. 17, 2010

(30) Foreign Application Priority Data
Dec. 16, 2009 (JP) 2009-284736

(51) Int. Cl. H04N 5/228

(52) U.S. Cl. 348/222.1; 348/E05.031

(57) ABSTRACT

An electronic camera includes an imager. An imager, having an imaging surface capturing a scene through a focus lens, repeatedly outputs a scene image. An extractor checks the scene image outputted from the imager with each of a plurality of characteristic patterns so as to extract a specific characteristic pattern satisfying a predetermined condition. A restrictor restricts behavior of adjusting a distance from the focus lens to the imaging surface in association with an extraction process of the extractor. A creator creates a reference image based on the scene image outputted from the imager corresponding to the extraction of the specific characteristic pattern. A register registers the specific characteristic pattern as a characteristic pattern used for searching for an image coincident with the reference image created by the creator.

### CROSS REFERENCE OF RELATED APPLICATION

The disclosure of Japanese Patent Application No. 2009-284736, which was filed on Dec. 16, 2009, is incorporated herein by reference.

### BACKGROUND OF THE INVENTION

1. Field of the Invention

The present invention relates to an electronic camera. More particularly, the present invention relates to an electronic camera which searches for an image coincident with a designated image from a scene image outputted from an imaging device.

2. Description of the Related Art

According to one example of this type of camera, when a shutter button is half depressed, a focus lens is set to a pan-focus state, and thereafter, a face-recognition process is executed. Thereby, when a face of a human is recognized, a position of the recognized face is determined as an AF area, and a contrast AF process is executed by noticing the determined AF area. A still-image photographing process is executed in response to fully depression of the shutter button.

However, in the above-described camera, the contrast AF process is executed after the face-recognition process, and therefore, a time lag which is attributed to the contrast AF process arises by the time the still-image photographing process is performed. As a result, the face recognized by the face-recognition process is oriented to another direction at a time point of the still-image photographing process, and thereby, the quality of a still image may be deteriorated.

### SUMMARY OF THE INVENTION

An electronic camera according to the present invention, comprises: an imager, having an imaging surface capturing a scene through a focus lens, which repeatedly outputs a scene image; an extractor which checks the scene image outputted from the imager with each of a plurality of characteristic patterns so as to extract a specific characteristic pattern satisfying a predetermined condition; a restrictor which restricts behavior of adjusting a distance from the focus lens to the imaging surface in association with an extraction process of the extractor; a creator which creates a reference image based on the scene image outputted from the imager corresponding to the extraction of the specific characteristic pattern; and a register which registers the specific characteristic pattern as a characteristic pattern used for searching for an image coincident with the reference image created by the creator.

An imaging control program product executed by a processor of an electronic camera provided with an imager, having an imaging surface capturing a scene through a focus lens, which repeatedly outputs a scene image, the imaging control program product comprises: an extracting step which checks the scene image outputted from the imager with each of a plurality of characteristic patterns so as to extract a specific characteristic pattern satisfying a predetermined condition; a restricting step which restricts behavior of adjusting a distance from the focus lens to the imaging surface in association with an extraction process of the extracting step; a creating step which creates a reference image based on the scene image outputted from the imager corresponding to the extraction of the specific characteristic pattern; and a registering step which registers the specific characteristic pattern as a characteristic pattern used for searching for an image coincident with the reference image created by the creating step.

An imaging control method executed by an electronic camera provided with an imager, having an imaging surface capturing a scene through a focus lens, which repeatedly outputs a scene image, the imaging control method comprises: an extracting step which checks the scene image outputted from the imager with each of a plurality of characteristic patterns so as to extract a specific characteristic pattern satisfying a predetermined condition; a restricting step which restricts behavior of adjusting a distance from the focus lens to the imaging surface in association with an extraction process of the extracting step; a creating step which creates a reference image based on the scene image outputted from the imager corresponding to the extraction of the specific characteristic pattern; and a registering step which registers the specific characteristic pattern as a characteristic pattern used for searching for an image coincident with the reference image created by the creating step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a configuration of a general dictionary referred to in the embodiment in FIG. 2;

FIG. 4 is an illustrative view showing one example of a configuration of a register referred to in a pet registration mode;

FIG. 5 is an illustrative view showing one example of an image representing an animal captured in the pet registration mode;

FIG. 6 is an illustrative view showing another example of the image representing the animal captured in the pet registration mode;

FIG. 7 is an illustrative view showing one example of a state where an evaluation area is allocated to an imaging surface;

FIG. 8 is an illustrative view showing one example of an extraction dictionary created in the pet registration mode;

FIG. 9 is an illustrative view showing another example of the extraction dictionary created in the pet registration mode;

FIG. 10 is a timing chart showing one portion of behavior in the pet registration mode;

FIG. 11 is an illustrative view showing one example of a registered pet image displayed on a monitor screen in a pet imaging mode;

FIG. 12 is an illustrative view showing one example of a face-detection frame structure used in an imaging-use face detecting task;

FIG. 13 is an illustrative view showing one portion of a face detection process in the imaging-use face detecting task;

FIG. 14 is an illustrative view showing one example of an image representing an animal captured in the pet imaging mode;

FIG. 15 is an illustrative view showing another example of the image representing the animal captured in the pet imaging mode;

FIG. 16 is a flowchart showing one portion of behavior of a CPU applied to the embodiment in FIG. 2;

FIG. 17 is a flowchart showing another portion of behavior of the CPU applied to the embodiment in FIG. 2;

FIG. 18 is a flowchart showing still another portion of behavior of the CPU applied to the embodiment in FIG. 2;

FIG. 19 is a flowchart showing yet another portion of behavior of the CPU applied to the embodiment in FIG. 2;

FIG. 20 is a flowchart showing another portion of behavior of the CPU applied to the embodiment in FIG. 2;

FIG. 21 is a flowchart showing still another portion of behavior of the CPU applied to the embodiment in FIG. 2;

FIG. 22 is a flowchart showing yet another portion of behavior of the CPU applied to the embodiment in FIG. 2;

FIG. 23 is a flowchart showing another portion of behavior of the CPU applied to the embodiment in FIG. 2;

FIG. 24 is a flowchart showing one portion of behavior of the CPU applied to another embodiment;

FIG. 25 is a flowchart showing one portion of behavior of the CPU applied to still another embodiment;

FIG. 26 is a flowchart showing one portion of behavior of the CPU applied to yet another embodiment; and

FIG. 27 is a flowchart showing another portion of behavior of the CPU applied to yet another embodiment.

### DETAILED DESCRIPTION OF THE PREFERRED EMBODIMENTS

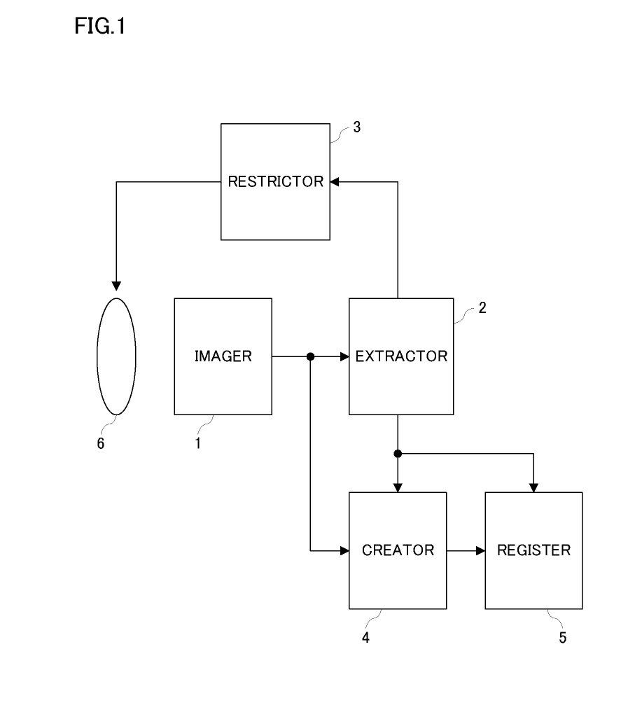

With reference to FIG. 1, an electronic camera of one embodiment of the present invention is basically configured as follows: An imager 1, having an imaging surface capturing a scene through a focus lens 6, repeatedly outputs a scene image. An extractor 2 checks the scene image outputted from the imager 1 with each of a plurality of characteristic patterns so as to extract a specific characteristic pattern satisfying a predetermined condition. A restrictor 3 restricts behavior of adjusting a distance from the focus lens 6 to the imaging surface in association with an extraction process of the extractor 2. A creator 4 creates a reference image based on the scene image outputted from the imager 1 corresponding to the extraction of the specific characteristic pattern. A register 5 registers the specific characteristic pattern as a characteristic pattern used for searching for an image coincident with the reference image created by the creator 4.

The behavior which adjusts the distance from the focus lens 6 to the imaging surface is restricted in association with the extraction of the specific characteristic pattern, and the reference image is created based on the scene image outputted from the imager 1 corresponding to the extraction of the specific characteristic pattern. Thereby, a time period from a timing of extracting the specific characteristic pattern to a timing of creating the reference image is shortened, and the quality of the reference image is improved.

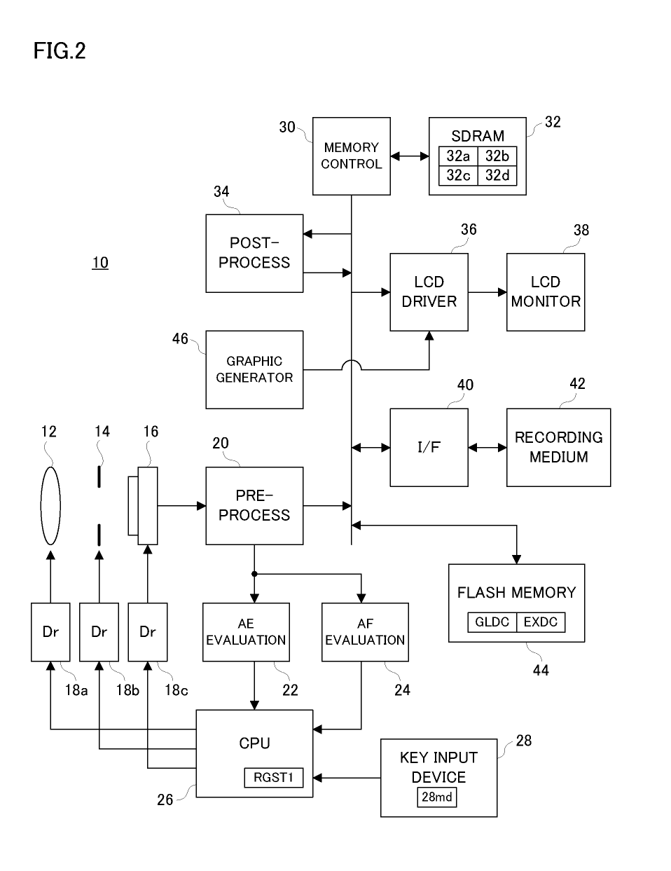

With reference to FIG. 2, a digital camera 10 according to this embodiment includes a focus lens 12 and an aperture unit 14 respectively driven by drivers 18a and 18b. An optical image of the object scene that undergoes these components enters, with irradiation, the imaging surface of an imager 16, and is subjected to a photoelectric conversion. Thereby, electric charges representing the scene image are produced.

When a power source is applied, a CPU 26 determines a setting (i.e., an operation mode at a current time point) of a mode selector switch 28md arranged in a key input device 28, under a main task If the operation mode at the current time point is a pet registration mode, a pet registering task and a registration-use face detecting task are started up. Moreover, if the operation mode at the current time point is a pet imaging mode, on the condition that a pet image is already registered, a pet imaging task and an imaging-use face detecting task are started up.

When the pet registration mode is selected, the CPU 26 enables a pan-focus setting under the pet registering task. The drivers 18a and 18b respectively adjust a position of the focus lens 12 and an aperture amount of the aperture unit 14 so that a depth of field becomes deep. Subsequently, the CPU 26 commands a driver 18c to repeat an exposure procedure and an electric-charge reading-out procedure in order to start a moving-image taking process. In response to a vertical synchronization signal Vsync periodically generated from an SG (Signal Generator) not shown, the driver 18c exposes the imaging surface and reads out the electric charges produced on the imaging surface in a raster scanning manner. From the imager 16, raw image data based on the read-out electric charges is outputted periodically.

A pre-processing circuit 20 performs processes, such as digital clamp, pixel defect correction, and gain control, on the raw image data which is outputted from the imager 16. The raw image data on which such pre-processes are performed is written into a raw image area 32a of an SDRAM 32 through a memory control circuit 30.

A post-processing circuit 34 reads out the raw image data accommodated in the raw image area 32a through the memory control circuit 30, performs processes such as a color separation process, a white balance adjusting process, a YUV converting process and etc., on the read-out raw image data, and individually creates display image data and search image data that comply with a YUV format. The display image data is written into a display image area 32b of the SDRAM 32 by the memory control circuit 30. The search image data is written into a search image area 32c of the SDRAM 32 by the memory control circuit 30.

An LCD driver 36 repeatedly reads out the display image data accommodated in the display image area 32b through the memory control circuit 30, and drives an LCD monitor 38 based on the read-out image data. As a result, a real-time moving image (through image) of the scene is displayed on a monitor screen.

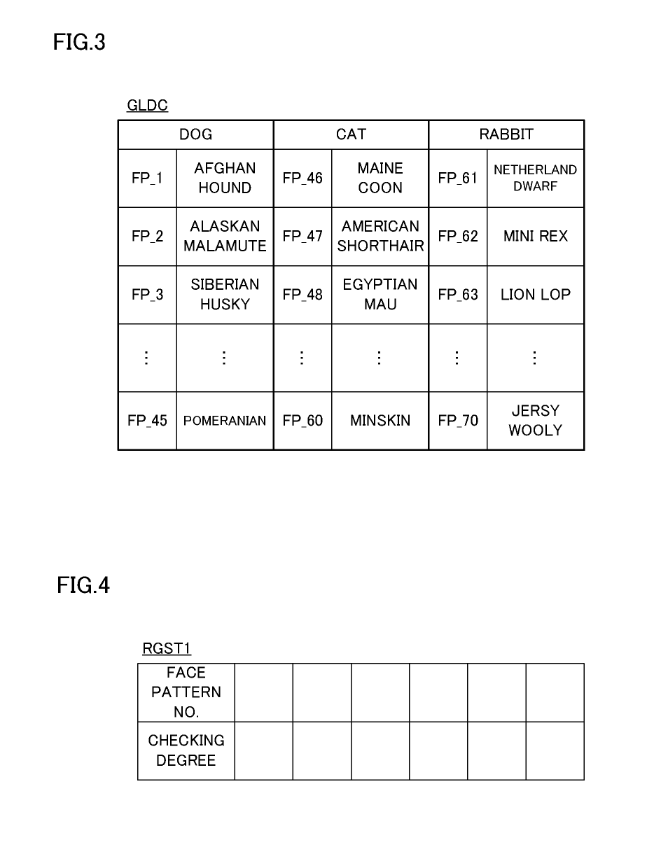

Moreover, under the registration-use face detecting task executed in parallel with the pet registering task, the CPU 26 searches for a face image of an animal from the search image data accommodated in the search image area 32c. For the registration-use face detecting task, a general dictionary GLDC shown in FIG. 3 and a register RGST1 shown in FIG. 4 are prepared. In the general dictionary GLDC shown in FIG. 3, face patterns FP_{—}1 to FP_{—}45 respectively represent characteristics of faces of dogs of 45 species, face patterns FP_{—}46 to FP_{—}60 respectively represent characteristics of faces of cats of 15 species, and face patterns FP_{—}61 to FP_{—}70 respectively represent characteristics of faces of rabbits of 10 species. That is, in FIG. 3, a name of the species is allocated to each of face pattern numbers FP_{—}1 to FP_{—}70, however, in reality, a characteristic amount of the face is allocated.

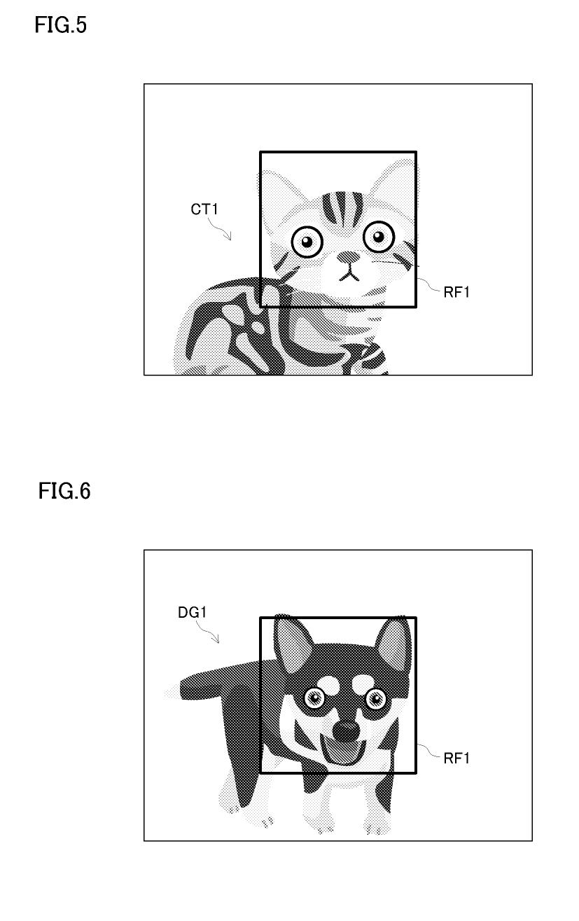

Under the registration-use face detecting task, firstly, a graphic generator 46 is requested to display a registration frame structure RF1. The graphic generator 46 outputs graphic data representing the registration frame structure RF1 toward the LCD driver 36. The registration frame structure RF1 is displayed at a center of the LCD monitor 38 as shown in FIG. 5 or FIG. 6.

Subsequently, a flag FLG_A is set to “0”, and a flag FLG_B is set to “0”. Herein, the flag FLG_A is a flag for identifying whether or not a face pattern in which a checking degree exceeds a reference value REF is discovered, and “0” indicates being undiscovered while “1” indicates being discovered. Moreover, the flag FLG_B is a flag for identifying whether or not a reference-face-pattern number is determined, and “0” indicates being undetermined while “1” indicates being determined. It is noted that the reference-face-pattern number is a face pattern number which is referred to in image searching under the imaging-use face detecting task.

When the vertical synchronization signal Vsync is generated, partial image data belonging to the registration frame structure RF1 is read out from the search image area 32c so as to calculate a characteristic amount of the read-out image data. Thus, in a case where a cat CT1 is captured as shown in FIG. 5, a characteristic amount of a face of the cat CT1 is calculated. Moreover, in a case where a dog DG1 is captured as shown in FIG. 6, a characteristic amount of a face of the dog DG1 is calculated.

Subsequently, a variable K is set to each of “1” to “70”, the calculated characteristic amount is checked with a characteristic amount of a face pattern FP_K. When a checking degree exceeds the reference value REF, the current face pattern number (=FP_K) and the checking degree are registered in the register RGST1, and the flag FLG_A is updated to “1”.

Regarding the cat CT1 shown in FIG. 5, a checking degree corresponding to an American Short Hair exceeds the reference value REF, and furthermore, a checking degree corresponding to an Egyptian Mau exceeds the reference value REF. Thus, in the register RGST1,the checking degree corresponding to the American Short Hair is registered together with a face pattern number of the American Short Hair (=FP_{—}47 ), and furthermore, the checking degree corresponding to the Egyptian Mau is registered together with a face pattern number of the Egyptian Mau (=FP_{—}48).

Regarding the dog DG1 shown in FIG. 6, a checking degree corresponding to an Alaskan Malamute exceeds the reference value REF, and furthermore, a checking degree corresponding to a Siberian Husky exceeds the reference value REF. Thus, in the register RGST1, the checking degree corresponding to the Alaskan Malamute is registered together with a face pattern number of the Alaskan Malamute (=FP_{—}2), and furthermore, the checking degree corresponding to the Siberian Husky is registered together with a face pattern number of the Siberian Husky (=FP_{—}3).

When the flag FLG_A indicates “1” at a time point at which the above-described process corresponding to K=70 is completed, out of face pattern numbers registered in the register RGST1, a face pattern number corresponding to a maximum checking degree is determined as the reference-face-pattern number. In an example of FIG. 5, when the checking degree corresponding to the American Short Hair is higher than the checking degree corresponding to the Egyptian Mau, “FP_{—}47” is determined as the reference-face-pattern number. Moreover, in an example of FIG. 6, when the checking degree corresponding to the Siberian Husky is higher than the checking degree corresponding to the Alaskan Malamute, “FP_{—}3” is determined as the reference-face-pattern number. The flag FLG_B is updated to “1” in order to declare that the reference-face-pattern number is determined.

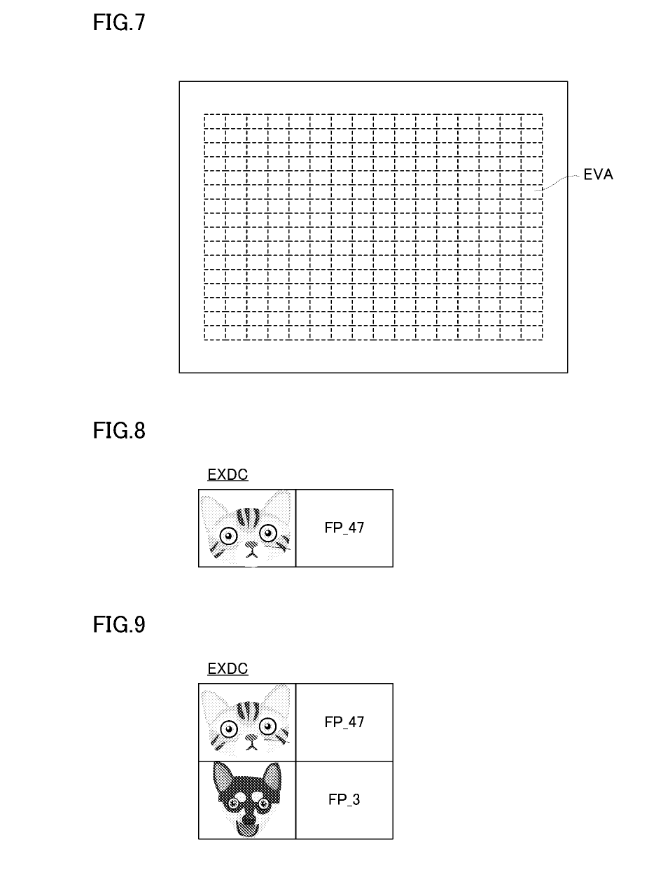

With reference to FIG. 7, an evaluation area EVA is allocated to a center of the imaging surface. The evaluation area EVA is divided into 16 portions in each of a horizontal direction and a vertical direction; therefore, 256 divided areas form the evaluation area EVA. Moreover, in addition to the above-described processes, the pre-processing circuit 20 executes a simple RGB converting process which simply converts the raw image data into RGB data.

An AE evaluating circuit 22 integrates RGB data belonging to the evaluation area EVA, out of the RGB data produced by the pre-processing circuit 20, at each generation of the vertical synchronization signal Vsync. Thereby, 256 integral values, i.e., 256 AE evaluation values, are outputted from the AE evaluating circuit 22 in response to the vertical synchronization signal Vsync.

Moreover, an AF evaluating circuit 24 extracts a high-frequency component of G data belonging to the same evaluation area EVA, out of the RGB data outputted from the pre-processing circuit 20, and integrates the extracted high-frequency component at each generation of the vertical synchronization signal Vsync. Thereby, 256 integral values, i.e., 256 AF evaluation values, are outputted from the AF evaluating circuit 24 in response to the vertical synchronization signal Vsync.

When the flag FLG_B indicates “0”, under the pet registering task, the CPU 26 executes a simple AE process that is based on the output from the AE evaluating circuit 22, so as to calculate an appropriate EV value. The simple AE process is executed in parallel with the moving-image taking process, and an exposure time period that defines the appropriate EV value in cooperation with an aperture amount corresponding to the pan-focus setting is set to the driver 18c. As a result, a brightness of the through image is adjusted moderately.

When the flag FLG_B is updated to “1”, the CPU 26 executes a strict AE process under the pet registering task. The strict AE process is also executed based on the output of the AE evaluating circuit 22, and thereby, an optimal EV value is calculated. To the driver 18c, the exposure time period that defines the optimal EV value in cooperation with the aperture amount corresponding to the pan-focus setting is set. As a result, the brightness of the through image is adjusted strictly. Upon completion of the strict AE process, the CPU 26 executes a still-image taking process. One frame of image data immediately after the strict AE process is completed is taken by the still-image taking process into a still-image area 32d.

Thereafter, the CPU 26 cuts out partial image data belonging to the registration frame structure RF1 out of the image data which is taken into the still-image area 32d, and reduces the cut-out image data. Thereby, registered pet image data is obtained. The registered pet image data is allocated to the reference-face-pattern number which is determined under the registration-use face detecting task The registered pet image data and the reference-face-pattern number being associated with each other are stored in a flash memory 44 as an extraction dictionary EXDC.

In the example of FIG. 5, registered pet image data representing the face of the cat CT1 is allocated to “FP_{—}47”. Moreover, in the example of FIG. 6, registered pet image data representing the face of the dog DG1 is allocated to “FP_{—}3”. Thus, when the cat CT1 shown in FIG. 5 is firstly photographed, the extraction dictionary EXDC shown in FIG. 8 is newly created. When the dog DG1 shown in FIG. 6 is subsequently photographed, the extraction dictionary EXDC is updated as shown in FIG. 9.

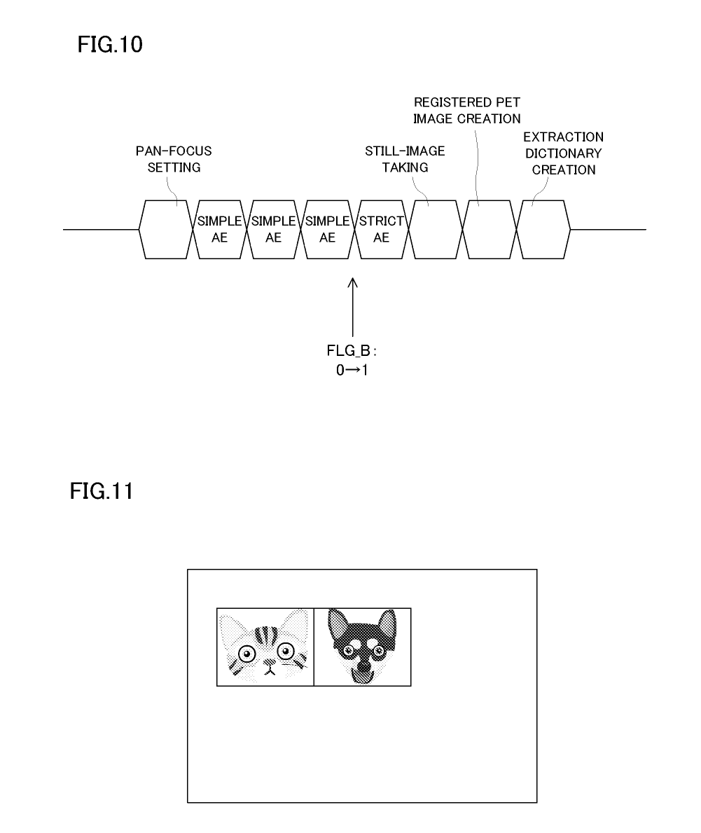

With reference to FIG. 10, the pan-focus setting is enabled concurrently with starting the moving-image taking process. When the flag FLG_B is updated from “0” to “1” (when the reference-face-pattern number is determined), the still-image taking process is executed without executing an AF process so as to create the registered pet image data based on the taken one frame of the image data. By omitting the AF process, a time period required for creating the registered pet image data is shortened, and therefore fine registered pet image data representing a face image directed to forward is obtained.

When the pet imaging mode is selected, the CPU 26 reads out the registered pet image data contained in the extraction dictionary EXDC from the flash memory 44 under the pet imaging task, and develops the read-out registered pet image data to the display image area 32b of the SDRAM 32. The LCD driver 36 reads out the developed registered pet image data through the memory control circuit 30, and drives the LCD monitor 38 based on the read-out registered pet image data.

Thus, when the extraction dictionary EXDC is created as shown in FIG. 9, two registered pet images representing the cat CT1 and the dog DG1 are displayed on the LCD monitor 38 as shown in FIG. 11.

When a selection operation which selects any one of the displayed registered pet images is performed, the CPU 26 reads out a characteristic amount of a reference face pattern corresponding to the selected registered pet image from the general dictionary GLDC. In a case where the registered pet image representing the cat CT1 is selected in the example of FIG. 11, a characteristic amount of the face pattern FP_{—}47 is read out from the general dictionary GLDC. Moreover, in a case where the registered pet image representing the dog DG1 is selected in the example of FIG. 11, a characteristic amount of the face pattern FP_{—}3 is read out from the general dictionary GLDC. Upon completion of reading out the characteristic amount of the reference face pattern, the moving-image taking process is started under the pet imaging task. Thereby, the real-time moving image (through image) of the scene is displayed on the monitor screen. Moreover, the search image data is repeatedly written in the search image area 32c.

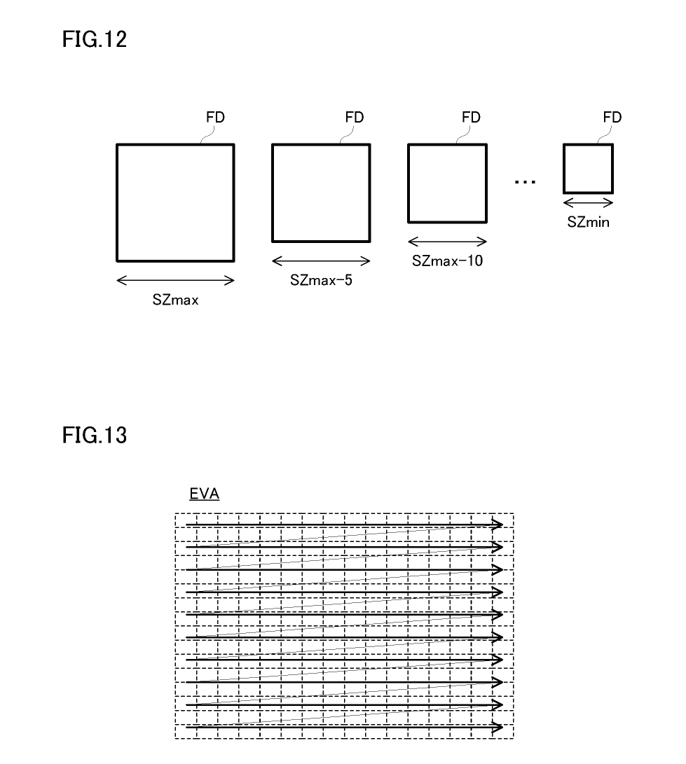

Moreover, under the imaging-use face detecting task executed in parallel with the pet imaging task, the CPU 26 searches for the face image of the animal from the search image data accommodated in the search image area 32c. The face image to be searched is the image coincident with the registered pet image which is selected by the selection operation. For the imaging-use face detecting task, a plurality of face-detection frame structures FD, FD, FD, . . . shown in FIG. 12 are prepared.

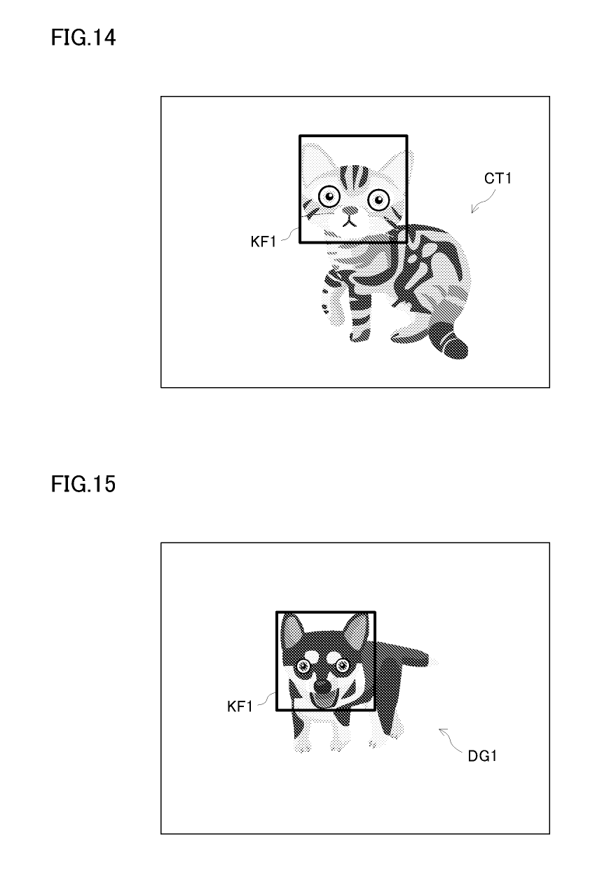

The face-detection frame structure FD is moved in a raster scanning manner corresponding to the evaluation area EVA on the search image area 32b (see FIG. 13), at each generation of the vertical synchronization signal Vsync. The size of the face-detection frame structure FD is reduced by a scale of “5” from “200” to “20” at each time the raster scanning is ended.

The CPU 26 reads out image data belonging to the face-detection frame structure FD from the search image area 32b through the memory control circuit 30 so as to calculate a characteristic amount of the read-out image data. The calculated characteristic amount is checked with the characteristic amount of the reference face pattern. When the checking degree exceeds the reference value REF, a position and a size of the face-detection frame structure FD at a current time point are determined as the position and size of the face image, and a flag FLGpet is updated from “0” to “1”.

Under the pet imaging task, the CPU 26 repeatedly executes the simple AE process corresponding to FLGpet=0. The brightness of the through image is moderately adjusted by the simple AE process. When the flag FLGpet is updated to “1”, the CPU 26 requests the graphic generator 46 to display a face frame structure KF1. The graphic generator 46 outputs graphic data representing the face frame structure KF1 toward the LCD driver 36. The face frame structure KF1 is displayed on the LCD monitor 38 in a manner adapted to the position and size of the face image which are determined under the imaging-use face detecting task

Thus, when the cat CT1 is captured in a state where the registered pet image of the cat CT1 is selected, the face frame structure KF1 is displayed on the LCD monitor 38 as shown in FIG. 14. Moreover, when the dog DG1 is captured in a state where the registered pet image of the dog DG1 is selected, the face frame structure KF1 is displayed on the LCD monitor 38 as shown in FIG. 15.

Thereafter, the CPU 26 executes the strict AE process and the AF process under the pet imaging task The AF process is executed based on the output of the AF evaluating circuit 24, and the focus lens 12 is set to a focal point which is discovered by the AF process. Thereby, a sharpness of the through image is improved.

Upon completion of the AF process, the still-image taking process and a recording process are executed. One frame of the image data immediately after the AF process is completed is taken by the still-image taking process into a still-image area 32d. The taken one frame of the image data is read out from the still-image area 32d by an I/F 40 which is started up in association with the recording process, and is recorded on a recording medium 42 in a file format The face frame structure KF1 is non-displayed after the recording process is completed.

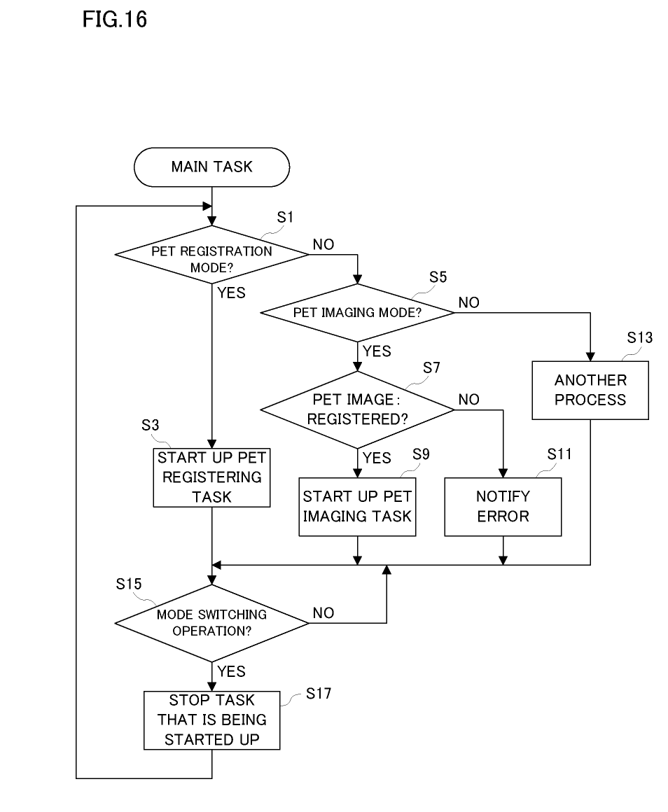

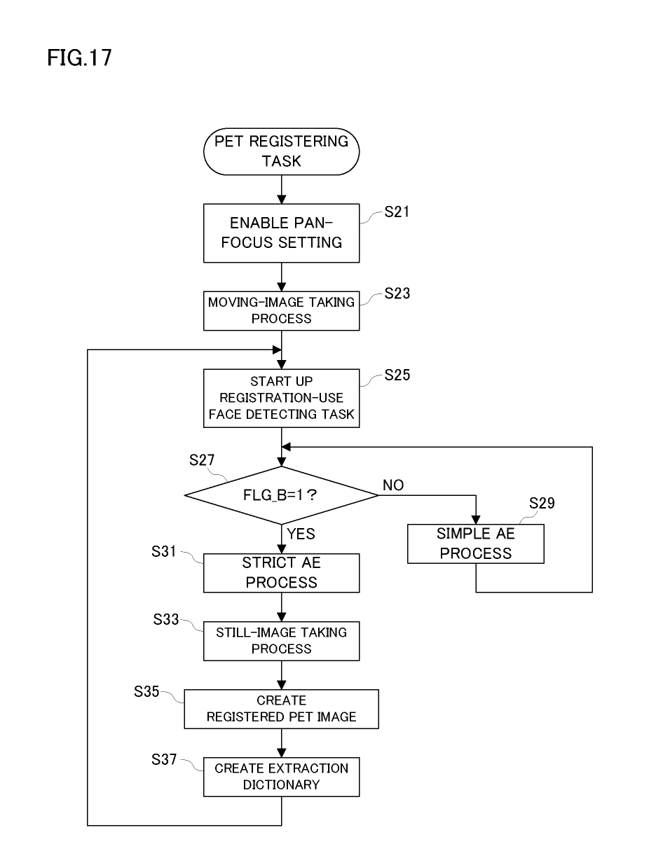

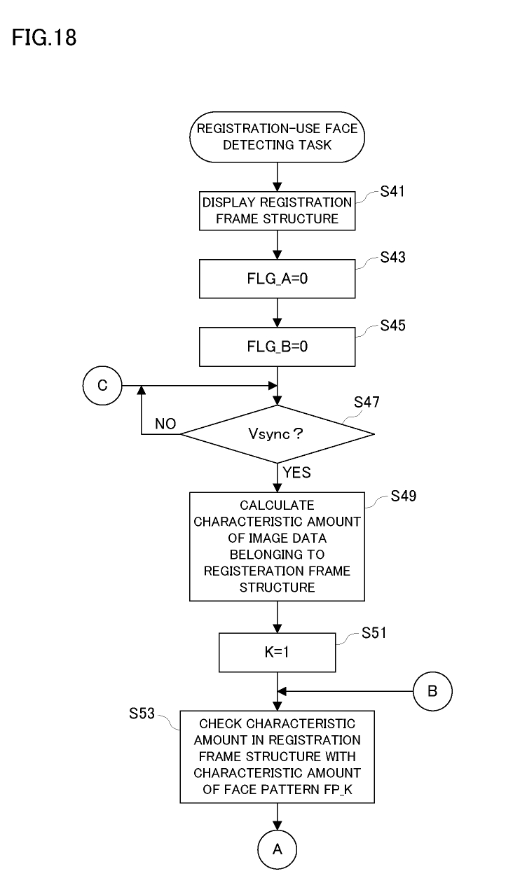

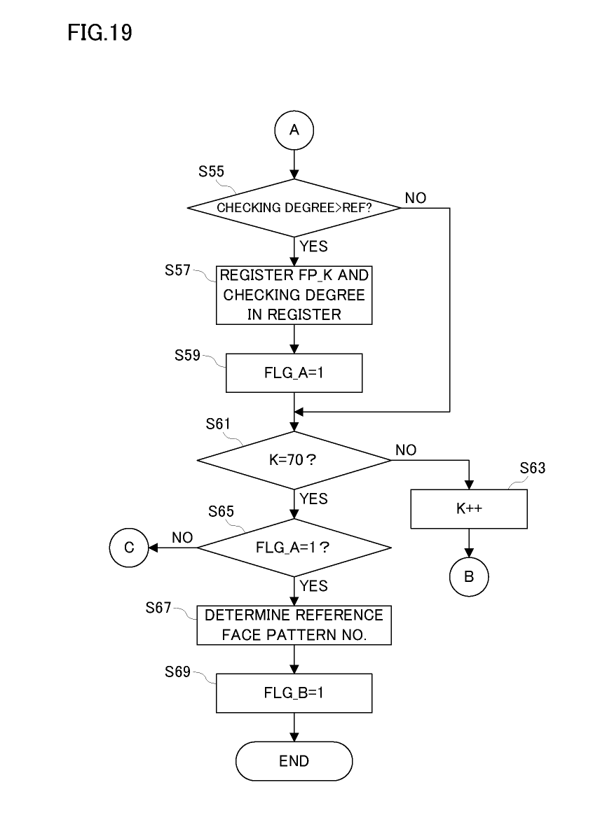

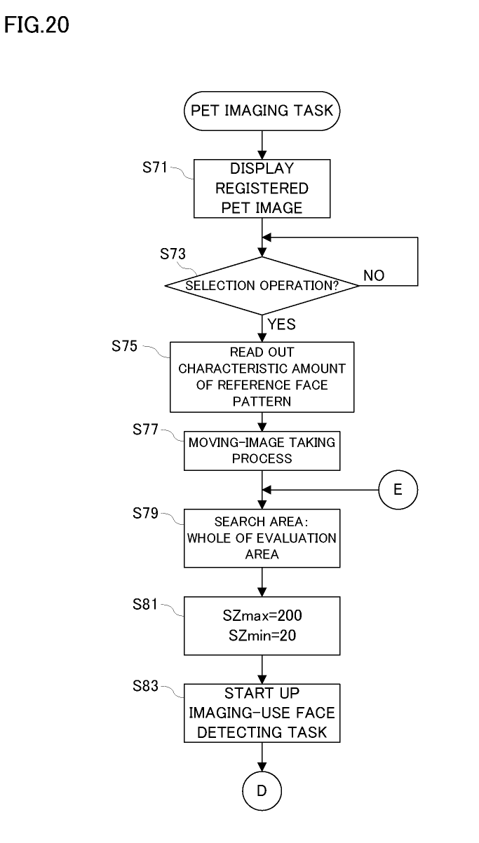

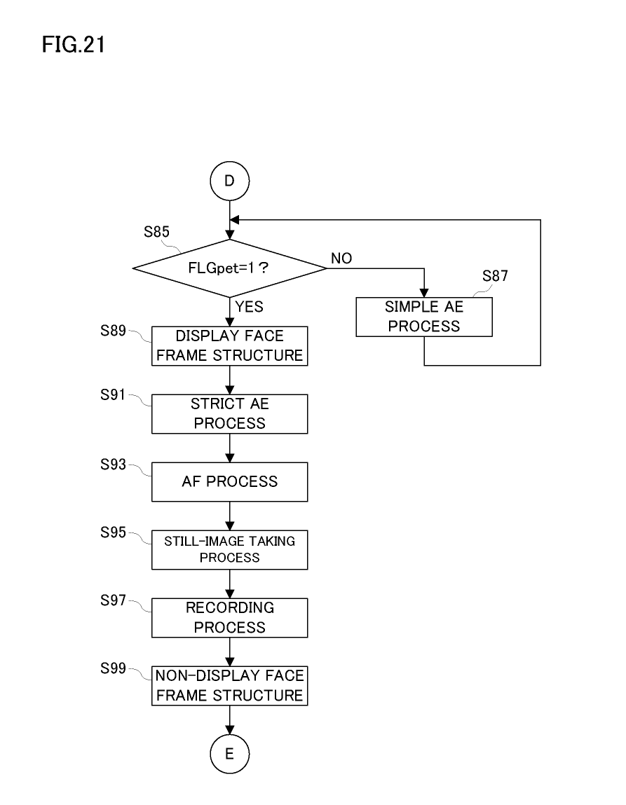

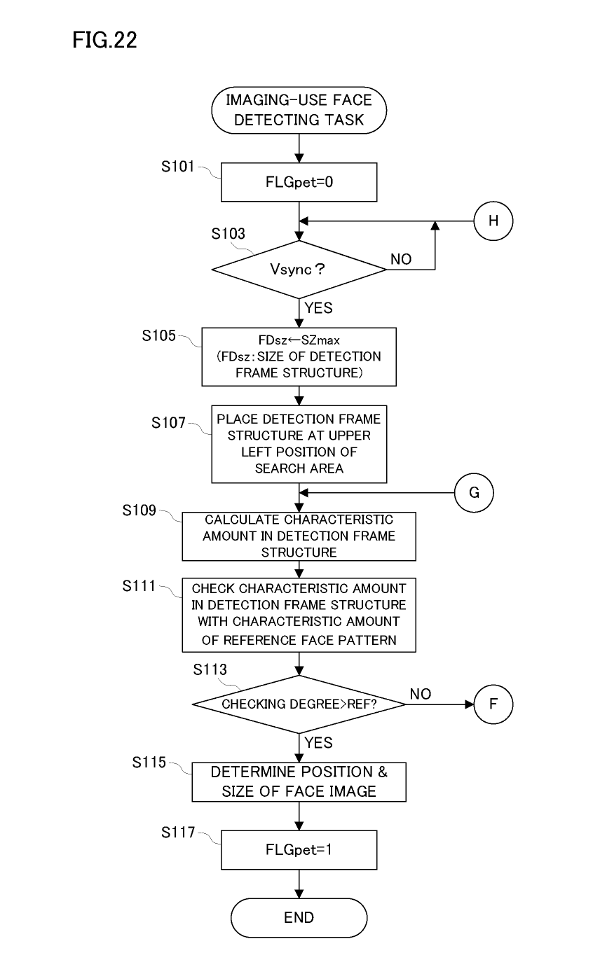

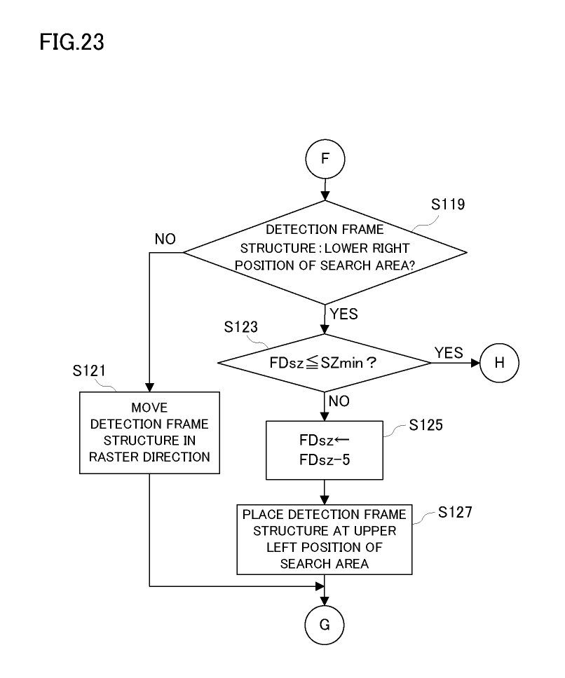

The CPU 26 executes a plurality of tasks including the main task shown in FIG. 16, the pet registering task shown in FIG. 17, the registration-use face detecting task shown in FIG. 18 to FIG. 19, the pet imaging task shown in FIG. 20 to FIG. 21, and the imaging-use face detecting task shown in FIG. 22 to FIG. 23. It is noted that control programs corresponding to these tasks are memorized in the flash memory 44.

With reference to FIG. 16, in a step S1, it is determined whether or not the operation mode at the current time point is the pet registration mode, and in a step S5, it is determined whether or not the operation mode at the current time point is the pet imaging mode. When YES is determined in the step S1, the pet registering task is started up in a step S3. When YES is determined in the step S5, it is determined whether or not the pet image is already registered (whether or not the extraction dictionary EXDC is already created) in a step S7.

When the determined result is YES, the pet imaging task is started up in a step S9 while when the determined result is NO, the CPU 26 notifies an error in a step S11. When NO is determined in both the steps Si and S5, another process is executed in a step S13. Upon completion of the processes in the steps S3, S9 and S11 or S13, it is repeatedly determined in a step S15 whether or not a mode switching operation is performed. When a determined result is updated from NO to YES, the task that is being started up is stopped in a step S17. Thereafter, the process returns to the step S1.

With reference to FIG. 17, in a step S21, the pan-focus setting is enabled, and in a step S23, the moving-image taking process is executed. As a result of the process in the step S21, the position of the focus lens 12 and the aperture amount of the aperture unit 14 are adjusted so that the depth of field becomes deep. Moreover, as a result of the process in the step S23, the through image representing the scene is displayed on the LCD monitor 38. In a step S25, the registration-use face detecting task is started up.

The flag FLG_B is set to “0” as an initial setting under the registration-use face detecting task, and is updated to “1” when the reference-face-pattern number is determined. In a step S27, it is determined whether or not the flag FLG_B indicates “1”, and when the determined result is NO, the simple AE process is executed in a step S29. Thereby, the brightness of the through image is adjusted moderately.

When the flag FLG_B is updated from “0” to “1”, the strict AE process is executed in a step S31, and the still-image taking process is executed in a step S33. As a result of the process in the step S31, the brightness of the through image is adjusted strictly. Moreover, as a result of the process in the step S33, one frame of the image data immediately after the strict AE process is completed is taken into the still-image area 32d.

In a step S35, the registered pet image data is created based on the image data taken into the still-image area 32d. In a step S37, the registered pet image data created in the step S35 is allocated to the reference-face-pattern number which is determined under the registration-use face detecting task Thereby, the extraction dictionary EXDC is newly or additionally created. Upon creation of the extraction dictionary EXDC, the process returns to the step S25.

With reference to FIG. 18, in a step S41, the graphic generator 46 is requested to display the registration frame structure RF1. Thereby, the registration frame structure RF1 is displayed at the center of the LCD monitor 38. In a step S43, the flag FLG_A is set to “0”, and in a step S45, the flag FLG_B is set to “0”. In a step S47, it is determined whether or not the vertical synchronization signal Vsync is generated, and when the determined result is updated from NO to YES, the process advances to a step S49. In the step S49, the partial image data belonging to the registration frame structure RF1 is read out from the search image area 32c so as to calculate the characteristic amount of the read-out image data.

In a step S51, the variable K is set to “1”, and in a step S53, the characteristic amount calculated in the step S49 is checked with the characteristic amount of the face pattern FP_K contained in the general dictionary GLDC. In a step S55, it is determined whether or not the checking degree exceeds the reference value REF, and when the determined result is NO, the process directly advances to a step S61 while when the determined result is YES, the process advances to the step S61 via steps S57 to S59. In the step S57, the current face pattern number (=FP_K) and the checking degree are registered in the register RGST1. In the step S59, the flag FLG_A is updated to “1” in order to declare that the face pattern in which the checking degree exceeds the reference value REF is discovered.

In the step S61, it is determined whether or not the variable K reaches “70”. When the determined result is NO, the variable K is incremented in a step S63, and thereafter, the process returns to the step S53 while when the determined result is YES, in a step S65, it is determined whether or not the flag FLG_A indicates “1”. When the flag FLG_A indicates “0”, the process returns to the step S47, and when the flag FLG_A indicates “1”, the reference-face-pattern number is determined in a step S67. The reference-face-pattern number is equivalent to the face pattern number corresponding to the maximum checking degree out of the face pattern numbers registered in the register RGST1. Upon completion of the process in the step S67, the flag FLG_B is updated to “1” in a step S69 in order to declare the determination of the reference-face-pattern number, and thereafter, the process is ended.

With reference to FIG. 20, in a step S71, the registered pet image data contained in the extraction dictionary EXDC is read out from the flash memory 44 so as to develop the read-out registered pet image data to the display image area 32b of the SDRAM 32. As a result, one or at least two registered pet images are displayed on the LCD monitor 38. In a step S73, it is determined whether or not the selection operation which selects any one of the displayed registered pet images is performed. When the determined result is updated from NO to YES, the process advances to a step S75 so as to read out the characteristic amount of the reference face pattern corresponding to the selected registered pet image from the general dictionary GLDC.

In a step S77, the moving-image taking process is executed, and in a step S79, whole of the evaluation area EVA is set as a search area. In a step S81, in order to define a variable range of the size of the face-detection frame structure FD, a maximum size SZmax is set to “200”, and the minimum size SZmin is set to “20”. Upon completion of the process in the step S81, the imaging-use face detecting task is started up in a step S83.

The flag FLGpet is set to “0” as an initial setting under the imaging-use face detecting task, and is updated to “1” when a face image coincident with the reference-face pattern is discovered. In a step S85, it is determined whether or not the flag FLGpet indicates “1”, and as long as the determined result is NO, the simple AE process is repeatedly executed in a step S87. The brightness of the through image is moderately adjusted by the simple AE process.

When the determined result is updated from NO to YES, the process advances to a step S89, so as to request the graphic generator 46 to display the face frame structure KF1. The graphic generator 46 outputs the graphic data representing the face frame structure KF1 toward the LCD driver 36. The face frame structure KF1 is displayed on the LCD monitor 38 in a manner to surround the detected face image.

In a step S91, the strict AE process is executed, and in a step S93, the AF process is executed. As a result of the strict AE process and the AF process, the brightness and focus of the through image are adjusted strictly. In a step S95, the still-image taking process is executed, and in a step S97, the recording process is executed. One frame of the image data immediately after the AF process is completed is taken by the still-image taking process into the still-image area 32d. The taken one frame of the image data is recorded by the recording process on the recording medium 42. Upon completion of the recording process, in a step S99, the graphic generator 46 is requested not to display the face frame structure KF1, and thereafter, the process returns to the step S79.

With reference to FIG. 22, in a step S101, the flag FLGpet is set to “0”, and in a step S103, it is determined whether or not the vertical synchronization signal Vsync is generated. When the determined result is updated from NO to YES, in a step S105, the size of the face-detection frame structure FD is set to “SZmax”, and in a step S107, the face-detection frame structure FD is placed at an upper left position of the search area. In a step S109, partial search image data belonging to the face-detection frame structure FD is read out from the search image area 32c so as to calculate a characteristic amount of the read-out search image data.

In a step S111, the calculated characteristic amount is checked with the characteristic amount of the reference face pattern which is read out from the general dictionary GLDC, and in a step S113, it is determined whether or not the checking degree exceeds the reference value REF. When the determined result is YES, the process advances to a step S115, and when the determined result is NO, the process advances to a step S119.

In the step S115, the position and size of the face-detection frame structure FD at the current time point are determined as the position and size of the face image. The determining process is reflected in the face-frame-structure display process in the above-described step S89.

The face frame structure KF1 is displayed on the LCD monitor 38 in a manner which adapts to the position and size of the face-detection frame structure FD at the current time point. Upon completion of the process in the step S115, the flag FLGpet is set to “1” in a step S117, and thereafter, the process is ended.

In the step S119, it is determined whether or not the face-detection frame structure FD reaches a lower right position of the search area. When the determined result is NO, in a step S121, the face-detection frame structure FD is moved in a raster direction by a predetermined amount, and thereafter, the process returns to the step S109. When the determined result is YES, in a step S123, it is determined whether or not the size of the face-detection frame structure FD is equal to or less than “SZmin”. When the determined result is NO, in a step S125, the size of the face-detection frame structure FD is reduced by “5”, and in a step S127, the face-detection frame structure FD is placed at the upper left position of the search area. Thereafter, the process returns to the step S109. When the determined result in the step S123 is YES, the process directly returns to the step S103.

As can be seen from the above-described explanation, the imager 16, having the imaging surface capturing the scene through the focus lens 12, repeatedly outputs the raw image data. The CPU 26 enables the pan-focus setting in order to restrict a focus adjusting operation (S21), and extracts the reference face pattern by checking the YUV-formatted image data based on the raw image data outputted in this state from the imager 16 with each of a plurality of face patterns contained in the general dictionary GLDC (S47 to S67). Moreover, the CPU 26 creates the registered pet image data based on the raw image data which is outputted from the imager 16 corresponding to the extraction of the reference face pattern (S33 to S35), and registers the reference face pattern as the face pattern used for searching for the image coincident with the created registered pet image data (S37).

Thus, the focus adjusting operation is restricted in association with the extraction of the reference face pattern, and the registered pet image data is created based on the raw image data which is outputted from the imager 16 corresponding to the extraction of the reference face pattern. Thereby, a time period from a timing of extracting the reference face pattern to a timing of creating the registered pet image data is shortened, and the quality of registered pet image data is improved.

It is noted that, in this embodiment, the pan-focus setting is enabled under the pet registering task to save the time period required for creating the pet image data.

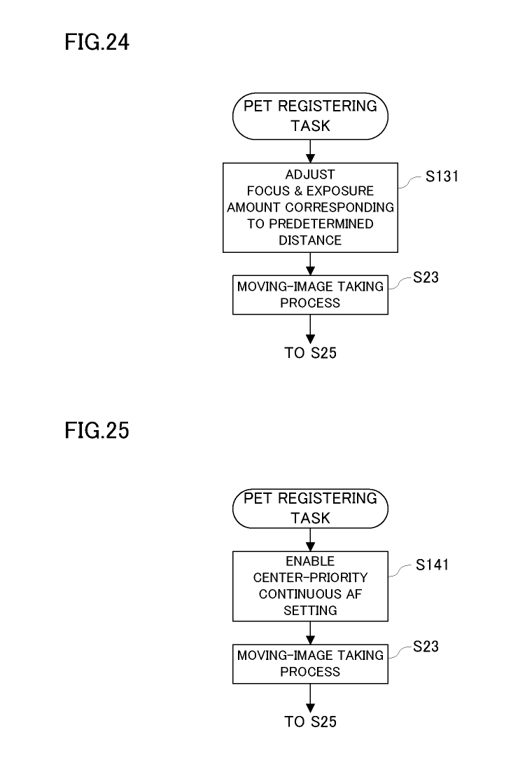

However, in the pet registration mode, it is necessary to contain the face image of the animal to the registration frame structure RF1 as shown in FIG. 5 or FIG. 6, and therefore, it becomes possible to predict a distance at this time from the imaging surface to the face of the animal. Therefore, instead of enabling the pan-focus setting, the focus and the aperture amount may be fixed corresponding to the predicted distance to the face of the animal. In this case, instead of the process in the step S21 shown in FIG. 17, the process in a step S131 shown in FIG. 24 (the process which adjusts the focus and the exposure amount corresponding to a predetermined distance) is executed.

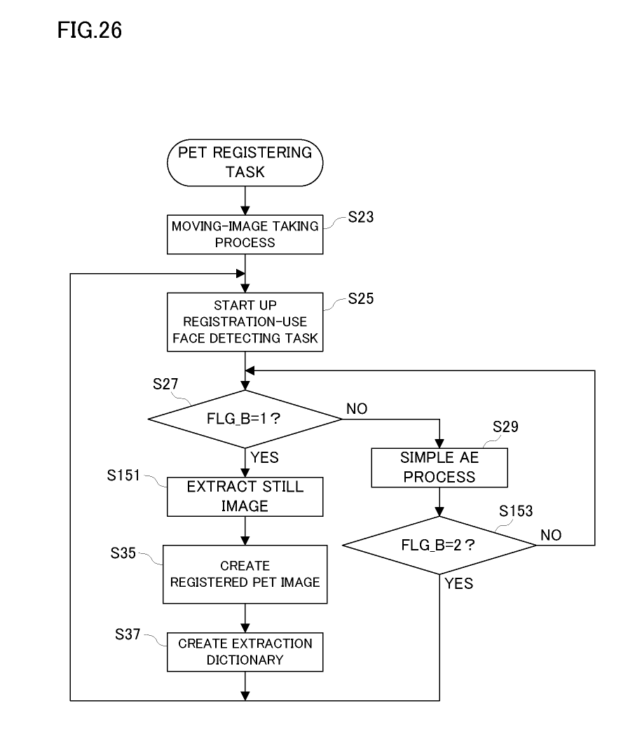

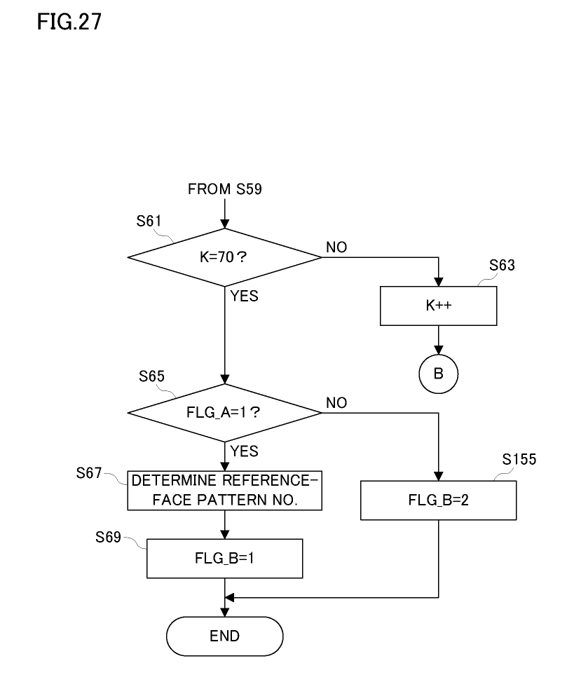

Moreover, when the face of the animal is contained in the registration frame structure RF 1 under the pet registering task, the operator continuously captures the face of the animal in a state where the distance to the animal is kept approximately the same distance. Therefore, instead of enabling the pan-focus setting, a center-priority continuous setting may be enabled at the same time of starting the moving-image taking process. In this case, instead of the process in the step S21 shown in FIG. 17, the process in a step S141 shown in FIG. 25 (the process which enables the center-priority continuous setting) is executed. As a result, the focus is continuously on the face of the animal under another task Moreover, in this embodiment, when the flag FLG_B is updated to “1”, the registered pet image data is created through the strict AE process and the still-image taking process (see the steps S27, S31 to S35 in FIG. 17). However, one frame of the image data accommodated in the display image area 32b may be extracted at a time point at which the flag FLG_B is updated to “1” so as to create the registered pet image data based on the extracted image data. In this case, the pet registering task shown in FIG. 17 and the registration-use face detecting task shown in FIG. 18 to FIG. 19 are partially corrected as shown in FIG. 26 to FIG. 27.

According to FIG. 26, the process which enables the pan-focus setting is omitted. Moreover, the process in a step S151 which extracts one frame of the image data from the display image area 32b is executed instead of the strict AE process and the still-image taking process. Furthermore, according to FIG. 27, when the determined result in the step S65 is NO, the flag FLG_B is set to “2” in a step S155. On the other hand, in FIG. 26, it is determined in a subsequent step S153 of the step S29 whether or not the flag FLG_B indicates “2”, and when the determined result is NO, the process returns to the step S27 while the determined result is YES, the process returns to the step S25.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager, having an imaging surface capturing a scene through a focus lens, which repeatedly outputs a scene image;
an extractor which checks the scene image outputted from said imager with each of a plurality of characteristic patterns so as to extract a specific characteristic pattern satisfying a predetermined condition;
a restrictor which restricts behavior of adjusting a distance from said focus lens to said imaging surface in association with an extraction process of said extractor;
a creator which creates a reference image based on the scene image outputted from said imager corresponding to the extraction of the specific characteristic pattern; and
a register which registers the specific characteristic pattern as a characteristic pattern used for searching for an image coincident with the reference image created by said creator.

2. An electronic camera according to claim 1, wherein the predetermined condition includes a condition under which a checking degree is maximum.

3. An electronic camera according to claim 1, wherein said register allocates the specific characteristic pattern to the reference image.

4. An electronic camera according to claim 1, wherein said restrictor enables a pan-focus setting.

5. An electronic camera according to claim 1, wherein each of the plurality of characteristic patterns is equivalent to a characteristic pattern of a face image of an animal, and said restrictor fixes the distance from said focus lens to said imaging surface on a predetermined distance corresponding to a size of the face image of the animal.

6. An electronic camera according to claim 1, wherein said restrictor enables a continuous AF setting in response to starting an imaging process of said imager.

7. An electronic camera according to claim 1, further comprising a first starter which starts up said extractor when an image registration mode is selected.

8. An electronic camera according to claim 1, further comprising:
a searcher which searches for an image coincident with a characteristic pattern selected by said selector out of the scene image outputted from said imager;
a recorder which records the scene image outputted from said imager corresponding to a discovery by said searcher; and
a second starter which starts up said searcher when an image recording mode is selected.

9. An imaging control program product executed by a processor of an electronic camera provided with an imager, having an imaging surface capturing a scene through a focus lens, which repeatedly outputs a scene image, the imaging control program product comprising:
an extracting step which checks the scene image outputted from said imager with each of a plurality of characteristic patterns so as to extract a specific characteristic pattern satisfying a predetermined condition;
a restricting step which restricts behavior of adjusting a distance from said focus lens to said imaging surface in association with an extraction process of said extracting step;
a creating step which creates a reference image based on the scene image outputted from said imager corresponding to the extraction of the specific characteristic pattern; and
a registering step which registers the specific characteristic pattern as a characteristic pattern used for searching for an image coincident with the reference image created by said creating step.

10. An imaging control method executed by an electronic camera provided with an imager, having an imaging surface capturing a scene through a focus lens, which repeatedly outputs a scene image, the imaging control method comprising:
an extracting step which checks the scene image outputted from said imager with each of a plurality of characteristic patterns so as to extract a specific characteristic pattern satisfying a predetermined condition;
a restricting step which restricts behavior of adjusting a distance from said focus lens to said imaging surface in association with an extraction process of said extracting step;
a creating step which creates a reference image based on the scene image outputted from said imager corresponding to the extraction of the specific characteristic pattern; and
a registering step which registers the specific characteristic pattern as a characteristic pattern used for searching for an image coincident with the reference image created by said creating step.
